(19) United States
(12) Patent Application Publication
(10) Pub. No.: US 2016/0312456 A1
(43) Pub. Date: Oct. 27, 2016

(54) WATER CLOSET

(71) Applicant: Duravit Aktiengesellschaft, Hornberg (DE)

(72) Inventors: Ralf MANTEL, Dusseldorf (DE); Sebastian SANDER, Waldkirch (DE)

(21) Appl. No.: 15/132,415

(22) Filed: Apr. 19, 2016

(30) Foreign Application Priority Data
Apr. 22, 2015 (DE) 10 2015 106 221.6

(51) Int. Cl. E03D 9/08; C02F 1/32

(52) U.S. Cl. CPC E03D 9/08; C02F 1/325

(57) ABSTRACT

A water closet including a flush toilet with a bowl and a shower device having an extendable nozzle for discharging water, wherein a water purification device installed upstream from the nozzle and including a UV ray-emitting radiation device is provided to purify the water dischargeable through the nozzle.

### CROSS-REFERENCE TO RELATED APPLICATIONS

The present application claims priority of DE 10 2015 106 221.6, filed Apr. 22, 2015, the priority of this application is hereby claimed and this application is incorporated herein by reference.

### BACKGROUND OF THE INVENTION

The invention pertains to a water closet comprising a flush toilet with a bowl and a shower device comprising an extendable nozzle for discharging water.

Sanitary facilities of the type described here comprising a flush toilet and an electronic shower device are becoming more and more popular for obvious hygienic reasons. The shower device with its extendable nozzle makes it possible to discharge water, which is sprayed through the nozzle toward the user. Because shower-flush toilet combinations of this type address a highly sensitive area of bodily hygiene, the topic of water quality becomes very important. Whereas primarily drinking water is used in European countries, in countries of other continents the regulations governing the quality of the water usable for this purpose are not always similarly strict.

If only for psychological reasons, the user will always have high expectations in regard to water quality. These cannot always be fulfilled, however, even when drinking water is used, because under certain conditions it can become contaminated, especially when allowed to stand for a long period of time.

### SUMMARY OF THE INVENTION

The invention is therefore based on the problem of providing a water closet which is improved with respect to the problem described above.

To solve this problem in a water closet of the type indicated above, a water purification device comprising a UV ray-emitting radiation device is provided according to the invention to purify the water which can be discharged through the nozzle, this radiation device being installed upstream from the nozzle.

According to the invention, the water which can be discharged through the nozzle toward the user is effectively purified by the treatment with UV rays. All of the water which arrives at the nozzle and is discharged through it is thus treated in this way; the water is thus subjected to an additional purification process to eliminate any contamination with microorganisms which may be present—even though it may already be of drinking water quality.

The radiation device provided for this purpose is installed in the water feed line to the nozzle; that is, the radiation device is arranged at a suitable point in the water feed line, so that the UV rays which it emits can treat the entire volume of water being supplied to the nozzle.

A UV(C) ray-emitting radiation device is preferably used. This radiation device emits very powerful short-wave UV rays. As a result of the radiation passing through it, the treated water becomes virtually free of microorganisms; it is possible to achieve a disinfection rate on the order of 4 logarithmic stages or more.

The water closet according to the invention thus permits effective water treatment and thus improves the degree of purity of the water to be used for personal hygiene.

According to a first alternative, which pertains to the arrangement of the radiation device, the device can be arranged in or on the water line through which the water dischargeable through the nozzle flows. The water which can be discharged through the nozzle is necessarily supplied through an appropriate water line. In or on this line, the radiation device is now arranged, so that it is ensured that the emitted UV radiation irradiates the entire volume of water. “Water line” in this context is either a solid or flexible conduit in the form of a pipe or hose, or it can be a housing connected to or mounted on such a line, in which housing the radiation device is arranged and through which the water is necessarily conducted. The radiation device is preferably located in or on a water line provided in the interior of a housing of the shower device. The radiation is device is therefore integrated into the shower device. The shower device normally comprises a housing, which encloses it externally, and in which the central components such as the extendable nozzle, a heating device, a pump, possibly a tank, and a control device, etc., are integrated. The water dischargeable through the nozzle is supplied from an external source. Inside the shower device, of course, it will be distributed and guided through appropriate sections of water line. In or on one of these sections of water line, the radiation device is arranged, either directly in the section of line or in the form of a separate housing, as previously described, which is connected to or mounted on such a water line or such a section of water line. The water purification process therefore takes place immediately before the water is discharged through the nozzle, which guarantees that the water discharged through the nozzle is always in a purified state.

The shower device usually comprises a feed valve to regulate the water feed; this valve is installed upstream of the nozzle. A water line through which the incoming water then continues to flow is provided downstream from this feed valve, usually a magnetic valve, which can be actuated by the control unit associated with the shower device. The radiation device will then be arranged in or on the water line, downstream from the feed valve. When the shower device is actuated, the control unit transmits a control pulse to the feed valve, preferably a magnetic valve as mentioned above, so that it opens and fresh water can enter. At the same time, the control unit also actuates the radiation device. This means that the entire amount of freshly arriving water is necessary irradiated, and thus only treated water arrives at the nozzle. When the purification process is over, the feed valve closes again, and the radiation device is turned off. Because the radiation device is in a position as close as possible downstream from the feed valve, however, it is guaranteed that only purified water is present in the water line between the feed valve and the nozzle. When a new shower process is initiated, the water being discharged at the beginning of the showering will also be in a purified state.

As an alternative to installing the radiation device downstream from the feed valve, it is also conceivable that it could be installed upstream from the feed valve, wherein there should be the shortest possible distance between the radiation device and the feed valve. The radiation device is therefore in or on the water line through which fresh, newly arriving water arrives at the feed valve. It is arranged to be as close possible to the plane of the valve, so that the length of line which can become contaminated between the radiation device and the feed valve is very short. When the showering process is started, the feed valve opens in his case, too, and simultaneously the radiation device is turned on. Again, therefore, only purified water flows via the feed valve to the nozzle. Upon completion of the showering process, the feed valve is closed again, and simultaneously or after a certain delay the radiation device is also deactivated. It is guaranteed again that only purified water is present between the feed valve and the nozzle.

As an alternative to the integration of the radiation device into the shower device, it is conceivable that the radiation device could be arranged outside the shower device in or on a water line which leads to the shower device and passes through an empty space in the flush toilet. As described, the fresh, incoming water is supplied through a water line, usually proceeding from the wall. Especially in the case of a wall-hung flush toilet, it is possible for the water line to be guided from the rear into an empty space in the flush toilet and to extend through a suitable opening into the shower device from underneath, the shower device being mounted on the rear of the flush toilet. According to the invention, the radiation device can now be arranged in or on this water line; that is, it will also be located in an empty space in the flush toilet. The radiation device is preferably installed in a position as close as possible to the shower device.

In another alternative arrangement, the radiation device can be arranged in or on a water line extending behind a front wall.

In this case, the radiation device is a certain distance away from the shower device. The water line in or on which the radiation device is arranged extends behind the front wall and passes through it into an empty space in the flush toilet, preferably from the rear, and then to the shower device. The feed valve is arranged at the inlet to the shower device. When the shower device is turned on, the feed valve is opened; preferably slightly before that or at least simultaneously, the radiation device is also activated. The water present at the feed valve has already passed through the radiation device during the previous showering process and is therefore in a purified state, so that purified water again flows to the nozzle even at the very beginning of the showering process. The incoming water is also purified by the radiation device. Because convection is minimal or completely absent, the water present between the radiation device and the feed valve is in a purified state, because there is only a negligible amount of convective mixing, if any at all, of the purified water downstream from the radiation device with the water present upstream of the radiation device.

This arrangement can be improved even more by providing the feed valve regulating the water feed to the shower device, i.e., the magnetic valve mentioned above, behind the front wall. This means that both the feed valve and the radiation device are located behind the front wall. The radiation device is positioned either downstream from the feed valve, preferably directly downstream from the feed valve, or it is installed upstream from the feed valve, preferably directly upstream. In either case, it is guaranteed that only purified water is present in the area of water line between the feed valve and the nozzle.

According to another alternative arrangement for installation on or in a water line, the radiation device is arranged in a water tank, in which the water to be discharged through the nozzle is stored. A water tank like this, which is used to prevent back-contamination as defined in DIN-EN 1717, is provided primarily in shower devices intended for the European market; it is therefore part of the shower device and integrated into the shower device housing. This water tank is always downstream from the feed valve, so that no unregulated feed and thus also no water exchange is possible. The radiation device is now, according to the invention, arranged in the water tank, through which necessarily all of the water supplied to the nozzle flows. Here, too, it is guaranteed that the water supplied to the nozzle has always been irradiated.

As previously described, the water tank can be arranged in the interior of the housing of the shower device, the feed valve being installed upstream of the tank. As an alternative, however, it is also conceivable that the water tank could be arranged behind a front wall. In this case, the magnetic valve is advisably arranged behind the front wall and upstream of the water tank.

In the water tank itself, it is advisable for there to be an air space between the water feed opening and the surface of the water, this air space usually being two or more centimeters high. The radiation source itself is arranged in the water, i.e., below the surface of the water. In this way a double layer of safety is obtained. First, because the radiation source is located in the water, the water in the tank is withdrawn and sent to the nozzle directly. Second, it is impossible for any microorganisms to jump across the air space and proceed backward, which means that the air space excludes the possibility of any recontamination. Because the feed valve is upstream from the water tank, no after-flow is possible either.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawing:

FIG. 1 shows a schematic diagram of a water closet according to the invention;

FIG. 2 shows a schematic diagram of a shower device representing part of the water closet of FIG. 1, in a first embodiment;

FIG. 3 shows a schematic diagram of a shower device representing part of a water closet of FIG. 1 according to the invention in a second embodiment;

FIG. 4 shows a schematic diagram of a water closet according to the invention of a second embodiment of the front wall-mounted type; and

FIG. 5 shows a schematic diagram of a water closet of another embodiment according to the invention, also of the front wall-mounted type.

### DETAILED DESCRIPTION OF THE INVENTION

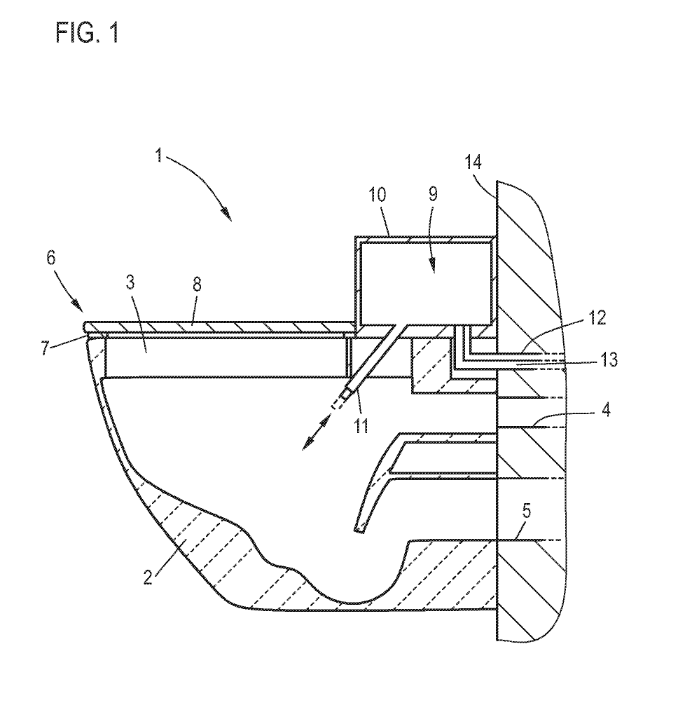

FIG. 1 shows a water closet 1 according to the invention, comprising a flush toilet 2, which is shown in cross section in the schematic diagram. It is usually made of ceramic, porcelain, or metal and comprises a bowl 3, into which flush water can flow from the flush water line 4, and from which wastewater can be discharged through wastewater line 5.

On the flush toilet 2, a lid-seat combination 6 is arranged in the known manner, wherein the seat 7 and the lid 8 are pivotably supported. In the rear area of the flush toilet, a shower device 9 is provided, which is accommodated in a housing 10, on which, for example, the seat 7 and the lid 8 are pivotably supported. The shower device 9, which is shown here in purely schematic fashion, comprises a nozzle 11, which can be extended into the bowl and through which water, usually heated water, can be discharged to the user for cleaning purposes.

The utility lines needed to operate the shower device 9 comprise a power line 12 and a water feed line 13, which, in the example shown here, pass behind a front wall 14 and are guided into the flush toilet from the rear through an appropriate front wall opening. Through an appropriate opening provided in the top of the flush toilet body or through several such openings, the utility lines 12, 13 are guided from below to the shower device 9 and connected to it as appropriate, wherein a connection interface can also be present in the area of the interior of the flush toilet.

The basic structure of a water closet of this type is generally known.

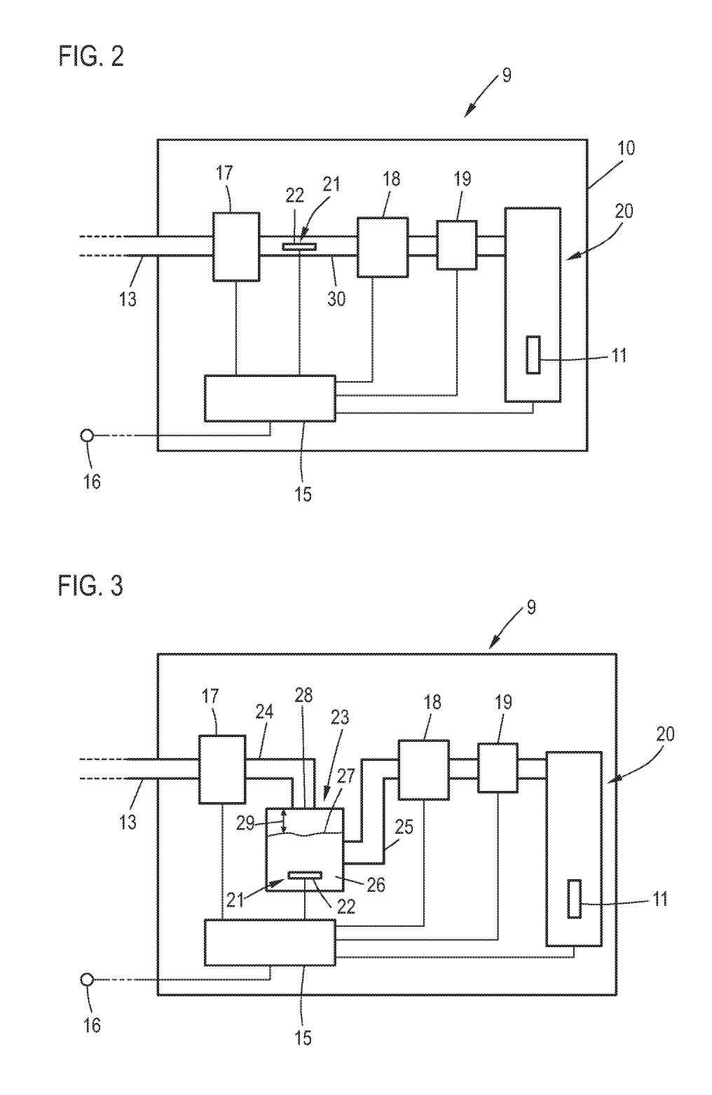

To guarantee that high-quality, purified water is always supplied through the nozzle 11 to the user, a water purification device, comprising a radiation device, is provided according to the invention, the water supplied to the nozzle 11 being irradiated by this purification device in order to kill any microorganisms which may be present. FIGS. 2-4 show various configurations of the water closet, pertaining in particular to the arrangement of the radiation device.

FIG. 2 shows a schematic diagram of the shower device 9 in its housing 10. The shower device 9 comprises a control unit 15, which controls the entire operation of the shower device 9 and which is connected to an actuating element 16 such as a pushbutton or the like, which the user actuates to initiate the showering process.

As previously described, a water feed line 13 runs into the shower device 9. At the downstream end of this feed line, a feed valve 17 such as a magnetic valve is installed, which is controlled by the control unit 15. As soon as the operating element 16 is actuated, the control unit 15 opens the feed valve 17, so that the fresh water present at the feed valve 17 can flow through the magnetic valve.

Also provided is a pump 18, which pumps the arriving water. Downstream from the pump 18 is a heating device 19, preferably a simple flow-through heater by way of example, which serves to temper the water to be supplied to the user. From the heating device 19, the heated water finally arrives at the nozzle device 20, comprising the extendable nozzle 11, which, under the action of the water pressure pushing against it or by electronic control means, travels out into the interior of the bowl, where the water is discharged toward the user.

Also provided is a radiation device 21 in the form of a UV(C) ray-emitting UV emitter 22. The operation of this emitter can also be controlled by the control unit 15. When the “start” signal is given by actuation of the operating element 16, the UV emitter 22 is also activated at the same time that the feed valve 17 is opened or possibly even somewhat before that. The emitter emits UV(C) rays. The entire volume of water supplied to the nozzle 11 flows past the emitter, so that all of the water supplied through the nozzle 11 is irradiated; UV(C) rays are germ-killing; that is, water which has been treated by it is almost completely antibacterial.

The radiation device 21 is arranged in a water line 30, which, in the example shown here, connects the feed valve 17 to the pump 18. The radiation device 21 should be downstream from the feed valve and as close a possible to it.

It should be kept in mind that, in the case of the embodiment according to FIG. 2, it is also possible in principle for the radiation device 21 to be installed directly upstream of the feed valve and preferably again in the interior of the housing 10. When the feed valve 17 is opened, the radiation device 21 is also turned on simultaneously, so that the water flowing through the feed valve 17 is already in a purified state.

In the embodiment according to FIG. 2, the control unit 21 could also be arranged outside the housing 10 but as close as possible to it on the upstream side, where it is integrated on or in the water line 13. In this case, the radiation device 21 will be located in an empty space inside the flush toilet 2, into which, coming from the wall, the water feed line 13 is guided, in which the radiation device 21 is installed.

FIG. 3 shows another embodiment of a shower device 9, wherein the same reference numbers are used for the same components. Again provided is a control unit 15 together with an operating element 16, as well as a feed valve 17, a pump 18, a heating device 19, and the nozzle device 20 with its extendable nozzle 11.

A water tank 23 is inserted in this case between the feed valve 17 and the pump 18. A section 24 of water line, coming from the feed valve 17, leads to the top of the water tank 23; a section of water line 25 runs from the water tank 23 to the pump 18. Water 26 to be supplied through the nozzle 11 is present in the water tank 23. Between the surface 27 of the water and the opening 28 of the water line section 24, an air space 29 is provided, which prevents contamination from proceeding backward toward the water feed line 13.

In this embodiment of the invention, the radiation device 21, again in the form of the UV(C) emitter 22, is located in the water tank 23, namely, in the water 26 itself. All of the water supplied to the nozzle 11 must flow through the water tank and therefore, because the radiation device 21 is integrated into the water tank 23, this water is necessarily irradiated. This means that all of the water discharged by the pump 18 is antibacterial.

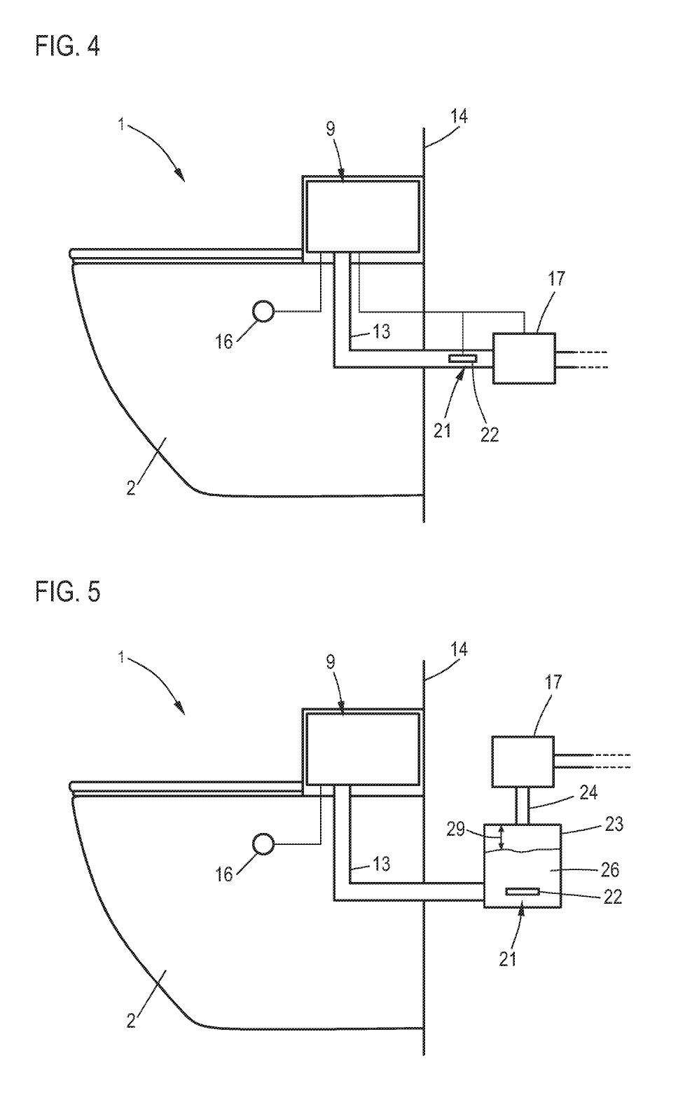

FIG. 4 shows another embodiment of a water closet 1 according to the invention, again comprising a flush toilet 2, shown here only in simplified form, on which a shower device 9 is arranged. The water feed line 13 is shown, which, by way of example, passes from the front wall 14 through an empty space in the flush toilet 2 to the bottom of the shower device 9 and is connected to it as appropriate.

In contrast to the embodiments described above, the feed valve 17 is not integrated here into the shower device 9 but is instead installed behind the front wall 14. The radiation device 21, that is, the UV(C) emitter 22, is installed in the water feed line 13. The radiation device 21 is also located behind the front wall 14 and is preferably positioned immediately downstream from the feed valve 17. The radiation device 21 and the feed valve 17 are again controlled by the control unit 15 of the shower device 9, when the operating element 16 is appropriately actuated. Because, upon completion of the showering process, the feed valve 17 is closed again, a closed section of water line is therefore present between the feed valve 17 and the nozzle 11. Because the radiation device 21 is arranged in this length of water line, namely, directly downstream from the feed valve 17, it is guaranteed that only purified water—purified because it has been irradiated—is present in this entire section of water line.

FIG. 5, finally, shows another embodiment of a water closet 1, again comprising the flush toilet 2 and the shower device 9. The water feed line 13, which passes through the interior of the flush toilet to the bottom of the shower device, is shown.

In this embodiment of the invention, the feed valve 17 is again arranged behind the front wall 14, and the water tank 23 is arranged downstream from the valve, also behind the front wall 14; the section 24 of water line coming from the feed valve 17 leads to the tank. The radiation device 21, again in the form of the UV(C) emitter 22, is again arranged in the water tank 23. The water 26 present in the water tank 23 is again separated by the air space 29 from the feed valve 17 and thus from the water feed line downstream from it.

The water 26 is again discharged by the pump 18, which, in this example, is arranged in the shower device 9, but which could just as well be installed behind the front wall 14, downstream from the water tank 23, the water then being sent to the nozzle 11. In this embodiment as well, it is guaranteed that only purified water—purified because it has been irradiated by the radiation device 21—is present in the entire length of water line between the feed valve 17 and the nozzle 11.

The radiation device 21 in the exemplary embodiments described above is shown integrated into the associated water line. Of course, it is also conceivable that the radiation device 21 could be provided with its own housing, through which the water to be purified flows, in which housing the UV(C) emitter 22 is arranged. This housing is then installed in an appropriate position in the water line in question and connected to the respective upstream and downstream components such as the feed valve 17.

As previously described, the entire operation of all the components is controlled by the control unit 15 of the shower device, wherein the individual components are obviously supplied as needed for their operation by way of the power line 12. The power line 12 has not been illustrated in FIGS. 2-5 for the sake of clarity.

While specific embodiments of the invention have been shown and described in detail to illustrate the inventive principles, it will be understood that the invention may be embodied otherwise without departing from such principles.

We claim:

1. A water closet, comprising a flush toilet with a bowl and a shower device comprising an extendable nozzle for discharging water, wherein a water purification device comprising a UV ray-emitting radiation device for purifying the water dischargeable through the nozzle is provided upstream from the nozzle.

2. The water closet according to claim 1, wherein the radiation device emits UV(C) rays.

3. The water closet according to claim 1, wherein the radiation device is arranged in or on a water line, through which the water dischargeable through the nozzle flows.

4. The water closet according to claim 3, wherein the radiation device is arranged in or on a water line provided in the interior of a housing of the shower device.

5. The water closet according to claim 4, wherein, to regulate the water feed, the shower device comprises a feed valve upstream from the nozzle, the water line being arranged downstream from the valve, wherein the radiation device is arranged in or on the water line downstream from the feed valve.

6. The water closet according to claim 4, wherein, to regulate the water feed, the shower device comprises a feed valve, which is installed upstream from the nozzle and upstream from which the water line is arranged, wherein the radiation device is arranged in the water line upstream from the feed valve.

7. The water closet according to claim 3, wherein the radiation device is arranged outside the shower device in or on a water line leading to the shower device and passing through an empty space of the flush toilet.

8. The water closet according to claim 3, wherein the radiation device is arranged in or on a water line passing behind a front wall.

9. The water closet according to claim 8, wherein, to regulate the water feed to the shower device, a feed valve is provided, which is installed behind the front wall, wherein the radiation device is arranged upstream or downstream from the feed valve.

10. The water closet according to claim 1, wherein the radiation device is arranged in a water tank, in which the water dischargeable through the nozzle is stored.

11. The water closet according to claim 10, wherein the water tank is arranged in the interior of a housing of the shower device.

12. The water closet according to claim 10, wherein the water tank is arranged behind a front wall.

13. The water closet according to claim 10, wherein, in the water tank, an air space is present between a water feed opening and the surface of the water, wherein the radiation source is arranged in the water.
